(19) United States
(12) Patent Application Publication
(10) Pub. No.: US 2011/0048429 A1
(43) Pub. Date: Mar. 3, 2011

(54) Patient Positioning Apparatus

(75) Inventor: Mark J. Callahan, Medway, MA (US)

(73) Assignee: Tyco Healthcare Group LP, Mansfield, MA (US)

(21) Appl. No.: 12/552,307

(22) Filed: Sep. 2, 2009

(51) Int. Cl. A61G 15/00

(52) U.S. Cl. 128/845

(57) ABSTRACT

A patient positioning apparatus includes a support member adapted for positioning beneath a patient and having an expandable material therein. The expandable material is adapted for transition from a first initial condition to a second expanded condition in the presence of an activating agent to facilitate support and stabilization of the body part with the support member and performance of a medical procedure. The expandable material may be a foamable liquid adapted to expand when subjected to the activating agent such as a propellant gas, air or foaming agent. In one application, the foamable liquid is a polyurethane.

### BACKGROUND

1. Technical Field

The present disclosure relates to a patient positioning apparatus, and, more particularly, relates to a patient positioning apparatus which, upon activation, can transform from a first transit condition to a second expanded condition to support and position a subject in a predetermined orientation during a surgical procedure.

2. Description of the Related Art

Patient positioning devices are commonly used during a surgical procedure to support and/or retain a limb, trunk or head of a patient in a stable position. Proper positioning with the devices restricts subject movement and reduces patient injury. A conventional positioning device is a pre-molded pad made from a foam or gel material. Foam positioning devices are available in a variety of sizes to accommodate patients of different sizes including infants, children and adults.

A drawback of conventional patient positioning devices is that they are pre-molded during manufacture and do not specifically conform to every patient body part, since every patient body part is different in size and shape. Many times the patient is placed in a position, which is not comfortable for the patient, while at the same time not convenient for the doctor. Patients under anesthesia require to be positioned in a manner that maintains an open air passage for unobstructed breathing. In addition, in that the anesthetized patients have no control on their body, the clinician normally is limited to the pre-molded arrangement of the patient positioning device to position the patient's body.

### SUMMARY

Accordingly, a patient positioning apparatus having the ability to conform to the body of the patient and at the same time accommodating the position and elevation selected by the doctor would provide significant clinical benefits. In one embodiment of the present disclosure, a patient positioning apparatus includes a support member adapted for positioning beneath a patient and having an expandable material therein. The expandable material is adapted for transition from a first initial condition to a second expanded condition in the presence of an activating agent to facilitate support and stabilization of the body part with the support member and performance of a medical procedure. The expandable material may be a foamable liquid adapted to expand when subjected to the activating agent such as a propellant gas, air or foaming agent. In one application, the foamable liquid is polyurethane.

Alternatively, the expandable member may include at least two liquid reactants which when mixed cause expansion to the second expanded condition. The at least two liquid reactants may be contained within respective frangible ampoules. The frangible ampoules are adapted for fragmentation through manipulation by the clinician at the operative site. In the alternative, a first of the at least two liquid reactants may be contained within a single frangible ampoule and a second of the at least two liquid reactants may be contained within the support member and surrounding the single frangible ampoule. The at least two liquid reactants may form a foamed polyurethane.

As a further alternative, an outer member is disposed about the support member. The outer member is dimensioned to encapsulate the expandable material. A patient contact member may be mounted to the outer member. The contact member may be dimensioned to contact the body part of the patient, and may be dimensioned to provide one of support to the patient or protection of the body part from any heat and/or cold generated during the reaction resulting from the mixing of the activating agent with the expandable material. The contact member may include one of a gel material or a foam material.

### BRIEF DESCRIPTION OF THE DRAWINGS

The foregoing features of the present disclosure will become more readily apparent and will be better understood by referring to the following detailed description of embodiments, which are described hereinbelow with reference to the drawings wherein:

FIG. 1 is a perspective view of a patient positioning apparatus in accordance with the principles of the present disclosure and as a component of a system for stabilizing a patient, and depicted in a first transit condition;

FIG. 2 is a perspective view of the patient positioning apparatus of FIG. 1 in a second expanded condition subsequent to activation;

FIGS. 3-4 are cross-sectional views of the patient positioning apparatus in the first transit and second expanded conditions, respectively;

FIGS. 5-6 are cross-sectional views of an alternate embodiment of the patient positioning apparatus in the first transit and second expanded conditions, respectively;

FIGS. 7-8 are cross-sectional views of another alternate embodiment of the patient positioning apparatus in the first transit and second expanded conditions, respectively;

FIGS. 9-10 are cross-sectional views of another alternate embodiment of the patient positioning apparatus in the first transit and second expanded conditions, respectively; and

FIG. 11 is a perspective view of another alternate embodiment of a patient positioning apparatus including detachable sections.

### DETAILED DESCRIPTION

The present disclosure generally includes a patient positioning system 10 having multiple embodiments of a patient positioning apparatus. The patient positioning apparatus may be constructed into different shapes and forms, including, e.g., intended for use as a head positioning pad, an arm positioning pad, a lumbar positioning pad, and a leg positioning pad, and any other patient positioning pads for supporting and elevating various patient body parts during a surgical procedure. The patient positioning apparatus or pad may be adapted to follow the contour of a specific body part of a patient and support the body part in a predetermined position. Each patient positioning pad may be packaged, shipped and delivered to a clinician (e.g., a nurse, a surgeon, a physical therapist, etc.) in a flat compact arrangement. Prior to, or during use, the patient positioning apparatus is activated by the clinician to expand and/or bend in order to contour and elevate the selected body part. The activation and method for altering the patient position device from a first condition to a second condition will be discussed in detail further below.

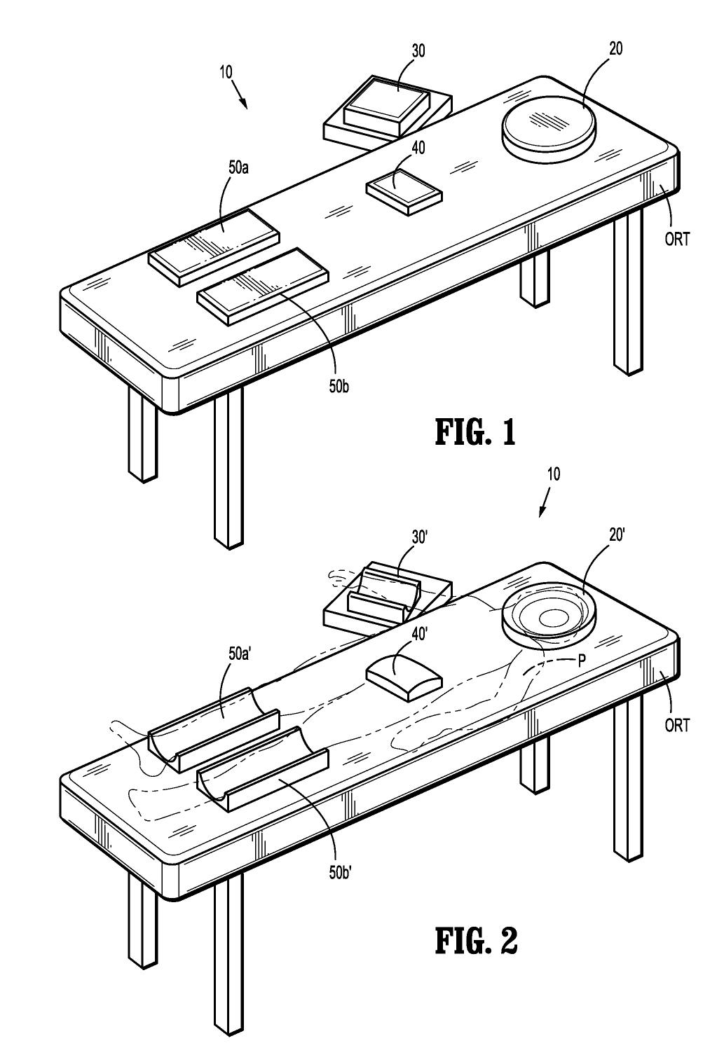

Referring initially to FIG. 1, a patient positioning system 10 of the present disclosure is illustrated. Patient positioning system 10 may include a plurality of patient positioning apparatuses, e.g., a head positioning apparatus or pad 20, an arm positioning pad 30, a lumbar positioning pad 40, and leg positioning pads 50a and 50b, arranged to be selectively placed on an operating room (OR) table beneath a patient. The patient positioning pads 20, 30, 40, 50a, and 50b are manufactured to assume a first condition or configuration, for example, a flat and compact position, as shown in FIG. 1, to accommodate easier shipping from a manufacturer and convenient storing for the clinician. The patient positioning pads 20, 30, 40, 50a, and 50b each include a material which may expand, e.g., in response to a stimulus, to elevate and support the body part in a stable condition. For example, each pad 20, 30, 40, 50a, and 50b may include an open or closed cell foam material (initially in liquid or solid form) adapted to expand to assume an enlarged conformable mass. Such foam materials include polyurethane, polystyrene or the like which may, or may not, be activated to expand in the presence of an activating agent. The activating agent may be mixed with the liquid foam polymer within the respective positioning pads at the surgical site through any number of conveyance means to be discussed hereinbelow.

FIG. 2 illustrates the patient positioning pads 20′, 30′, 40′, 50a′, and 50b′ in the second expanded condition subsequent to activation of the respective foam material. In the second condition, the patient positioning pads 20′, 30′, 40′, 50a′, and 50b′ are adapted to contour and bend about the respective body part of the patient P (shown in phantom) in order to maintain (e.g., keep in a stationary position) and/or elevate the body part to a comfortable and specific position selected by the clinician. The clinician may arrange the patient positioning pads 20′, 30′, 40′, 50a′, and 50b′, in any configuration, for example, any number of pads may be used to elevate and maintain a patient body part in a secure position, while the clinician performs a specific surgical procedure. The direction and orientation of expansion of the foam may be manipulated by the clinician during the expanding stage thereby providing an element of control over the final pad design. This customizing affect provides substantial benefits with respect to convenience and patient comfort.

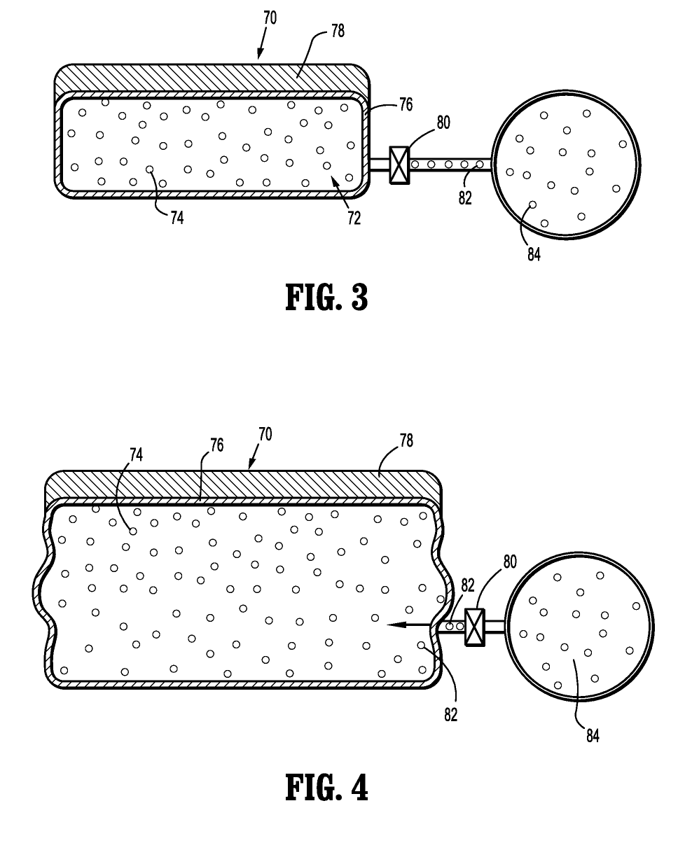

FIGS. 3 and 4 are cross-sectional views detailing one embodiment of construction of patient positioning pads 20, 30, 40, 50a, 50b. Patient positioning pad 70 includes support member 72 which may be, in its initial state, contain a foamable liquid 74, foamable gel or gelable liquid, e.g., including a polyurethane, polystyrene or polyvinyl alcohol. Patient positioning pad 70 optionally may include an outer member 76 partially surrounding support member 72. Outer member 76 may be a separate component from support member 72 and is dimensioned to at least partially encapsulate the foamable liquid 74. Any suitable material such as an elastomer or resilient material or the like may by incorporated within an outer member 76. For example, outer member 76 may be an expandable bladder adapted to expand during expansion of the foamable liquid 74. In the alternative, outer member 76 may be incorporated within support member 72.

Positioning pad 70 may include patient contact member 78 which may be secured to outer member 76 or integrally formed with the outer member 76. Contact member 78 may include a pre-formed suitable foam or get material, and is intended for directly contacting the patient. Contact member 78 provides an additional layer of support to the patient, and, also may protect the patient from any heat (via an exothermic reaction of liquid reactants) or cold generated when foamable liquid 74 expands to the foam composition.

In accordance with the embodiment of FIGS. 3 and 4, positioning pad 70 may include a valve 80 or the like for introducing an activating agent 82, e.g., a foaming agent, propellant gas or air to cause the foamable liquid or gel 74 to expand. Any suitable valve 80, such as a stop cock valve, is envisioned. The type of activating agent 82 introduced through valve 80 will be dependant upon the composition of the foamable liquid, and may be readily ascertained by one skilled in the art. A source of activating agent 84 may be in fluid communication with valve 80. FIG. 4 illustrates positioning pad or apparatus 70 in the expanded condition subsequent to the introduction of the activating agent 82. As noted, the activating agent 82 when mixed with the foamable liquid or gel 74 causes the liquid to expand to a foam-like composition and support. During the expansion, the clinician may manipulate positioning pad 70 in a manner to control the resulting configuration of the expanded foam, i.e. to achieve any desired contour of the expanded foam. It is envisioned that during expansion, the foam will expand and follow the natural contour of the selected body part, in effect, forming a custom fit with the body part even without the aforedescribed manipulation by the clinician. The custom fit minimizes the potential of irritation and stress on the body part while enhancing patient comfort. In addition, any heat generated during the reaction of the foamable liquid and the activating agent is absorbed by contact member 78 thus providing protection to the patient.

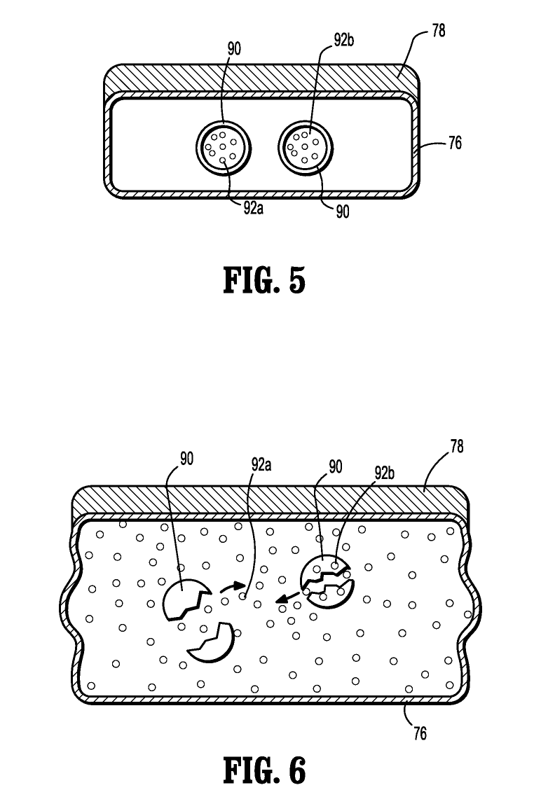

FIGS. 5-6 illustrate an alternate embodiment of patient positioning pad 70. In accordance with this embodiment, at least two frangible ampoules 90 are disposed within outer member 76. Ampoule 90 includes liquid reactants or resin 92a, 92b which, when mixed, expand to a foam-like structure, thus, expanding outer member 76. For example, one ampoule 90 may include a polyether polyol and the other ampoule 90 a diisocyanate. When mixed, the contents expand to form a polyurethane foam composition. Other liquid reactants to form an expandable foam are also envisioned. Ampoules 90 may be fragmented by the clinician at the operative site to cause release of the liquid reactants. Ampoules 90 may be segmented to facilitate fragmentation. Fragmentation of ampoules 90 may be confirmed through audible means such as the sound generated when the ampoules 90 are fragmented.

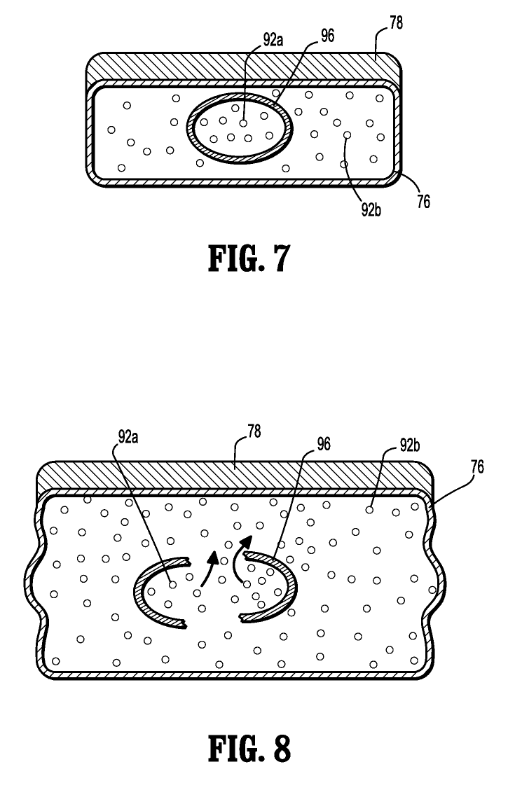

In another embodiment depicted in FIGS. 7-8, a patient positioning pad or device 70 includes a single ampoule 96, which contains one part of an epoxy mixture or liquid reactant 92a. Outer member 76 defines chamber 98 surrounding single ampoule 96 for accommodating the other liquid reactant 92b or mixture. Upon manual manipulation by the clinician, the single ampoule 96 is fragmented, which in turn, causes liquid reactants 92 to mix and create the foam composition.

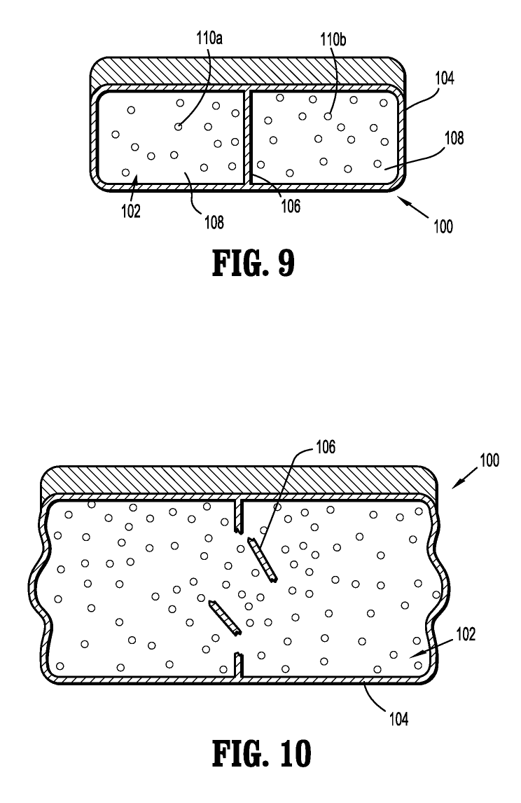

FIGS. 9-10 illustrate another embodiment of the patient positioning device configured to separate first and second liquid reactants. Patient positioning device 100 includes support member 102 and outer member 104 surrounding support member 102. Support member 102 includes frangible divider 106, which runs along the length or width of the support member 102 to define at least two chambers 108. Each chamber 108 has a liquid reactant 110a, 110b therein. Divider 106 is fragmented by the clinician to cause mixing of the liquid reactants 110a, 110b and production of the foam composition.

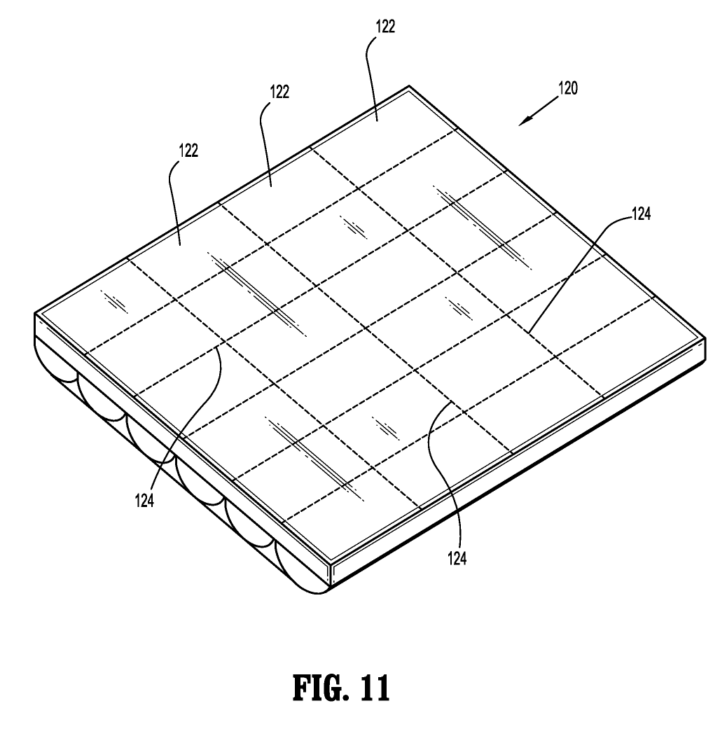

FIG. 11 illustrates a patient positioning pad 120 in accordance with another embodiment of the present disclosure. Positioning pad 120 is configured in a sheet-like arrangement. Patient positioning pad 120 includes individual patient position segments 122 connected to each other along adjacent perforated lines 124. In this embodiment, patient positioning pad or sheet 120 is manufactured in any suitable shape, for example, a rectangular shape. The clinician may simply detach as many patient positioning pad segments 122, etc. necessary to accommodate a body part for a particular surgical procedure by simply tearing the selected pad segments 122, etc along the perforated lines 124. Each positioning pad segment 122 may incorporate any of the aforementioned mechanisms for causing expansion of the formable liquids contained within respective pad segments 122.

In accordance with some embodiments, any of the patient positioning apparatii may be anchored to operating room (OR) table by any suitable conventional means including a magnetic fastener, VELCRO hook and loop fasteners, belt-strap fasteners, snap-fit fasteners, and suction cup fasteners.

It is envisioned that the activating agent used in some embodiments may be manually activated or released by the clinician (e.g., switch, breaking a seal, etc.). Alternatively, the activating agent may be automatically activated or released (e.g., sensor, timer, etc.). In further embodiments, the activating agent may be mechanically activatable upon reaching a threshold pressure, temperature, or any other suitable activatable means. In other embodiments, the patient positioning pad may be activated via an electrical stimulus to, e.g., initiating the chemical reaction between the two part liquid components.

Although the foregoing disclosure has been described in some detail by way of illustration and example, for purposes of clarity or understanding, it will be obvious that certain changes and modifications may be practiced within the scope of the appended claims.

What is claimed is:

1. A patient positioning apparatus, which comprises:
a support member adapted for positioning beneath a patient, the support member including an expandable material adapted for transition from a first initial condition to a second expanded condition in the presence of an activating agent.

2. The patient positioning apparatus according to claim 1, wherein the expandable material is a foamable liquid, the foamable liquid being expandable when subjected to the activating agent.

3. The patient positioning apparatus according to claim 2, wherein the activating agent is one of a propellant gas, air or foaming agent.

4. The patient positioning apparatus according to claim 2, wherein the foamable liquid is a polyurethane.

5. The patient positioning apparatus according to claim 1, wherein the expandable member includes at least two liquid reactants which when mixed cause expansion to the second expanded condition.

6. The patient positioning apparatus according to claim 5, wherein the at least two liquid reactants are contained within respective frangible ampoules.

7. The patient positioning apparatus according to claim 5, wherein one of the at least two liquid reactants is contained within a frangible ampoules, and a second of the at least two liquid reactants is contained within the support member.

8. The patient positioning apparatus according to claim 5, wherein the at least two liquid reactants form a foamed polyurethane.

9. The patient positioning apparatus according to claim 1, including an outer member, the outer member dimensioned to encapsulate the expandable material.

10. The patient positioning apparatus according to claim 9, including a contact member mounted to the outer member, the contact member dimensioned to contact the body part of the patient.

11. The patient positioning device according to claim 10, wherein the contact member includes one of a gel material or a foam material.
